(19) United States
(12) Patent Application Publication
(10) Pub. No.: US 2005/0280270 A1
(43) Pub. Date: Dec. 22, 2005

(54) Masterhook

(76) Inventor: Wesley Leroy Howard JR., Lincoln, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(21) Appl. No.: 10/869,377

(22) Filed: Jun. 17, 2004

(51) Int. Cl. B65G 7/12

(52) U.S. Cl. 294/17

(57) ABSTRACT

A tool is provided for both lifting manhole covers and smaller utility service box lids. An elongate arm has a handle at an upper end. A hook at the lower end is adapted to engage a notch in a manhole cover for pivoting the manhole cover out of position. A shaft in the lower end of the tool is provided with a tooth and a recess which are sized to engage a notch in a smaller utility service box lid. A fulcrum and a lever are rigidly secured to the shaft and the arm to both assist in freeing a tight lid from the associated hole and to allow the lid to be held entirely by the tool and lifted away from the hole with the tool only engaging one notch in the lid.

### FIELD OF THE INVENTION

The following invention relates to tools for lifting and moving manhole covers and other utility box access lids/covers. More particularly, this invention relates to tools which can both lift a manhole cover and a smaller utility box access lid/cover utilizing different portions of the same tool.

### BACKGROUND OF THE INVENTION

Manholes and other utility service box lids/covers are designed to make their removal somewhat difficult, so that they are not displaced by vehicular traffic passing over the top of the covers, and to discourage vandalism. However, such designs also make it difficult for authorized personnel to remove such covers when necessary. For manholes, excessive weight is utilized as a primary means to make removal difficult. Tools are known in the art for removal of manholes which are in the form of a long arm with a curving hook at the end for engaging a slot at an edge of the manhole cover. A handle is provided at the opposite end which can be held by a user. The hook catches the slot in the manhole cover and the user lifts on the handle to pivot up one side of the cover and rock it to the side. The manhole cover can thus be rotated out of position to provide access.

Smaller utility covers cannot effectively utilize weight to restrict access. For instance, one common sized cover is referred to as a “G-5” lid. It is often used for water valve boxes and other water service. Also, electrical boxes and other utilities are often provided with a rectangular cover which has a pair of slots not at edges of the cover, but at central locations within the cover which have a bar therein which can be accessed by a tool. These smaller covers can typically be lifted with a heavy duty screwdriver, or other thin elongate metal structure. However, to effectively utilize a screwdriver or similar tool the user must bend down rather low and will often do damage to the screwdriver. With some of the larger covers, such as the G-5 lids, a pair of screwdrivers are required and the leverage of the user is not particularly desirable, such that removal of the cover is made rather difficult. As a result, inspections take longer and time is wasted, while improper tools are damaged when utilized.

Accordingly, a need exists for a tool which can provide easy cover handling for both manhole covers and smaller utility service box lids/covers.

### SUMMARY OF THE INVENTION

With this invention a tool is provided both for lifting manhole covers and for handling smaller covers such as G-5 lids. The tool includes an elongate arm with an upper end adapted to be grasped by a user, such as through a handle. A lower end of the arm includes a curving hook which is adapted to slide into a notch in a manhole cover for lifting the manhole cover. On a side of the arm adjacent the hook, but on an opposite side of the arm, a shaft extends vertically downward. This shaft is sized sufficiently small to slide into a notch in a G-5 lid or other utility service box cover. A lower end of the shaft includes a tooth which can engage underneath the lid or under a prong provided within the notch for grasping purposes within the lid or cover. The tooth can thus engage the lid through the notch for lifting of the lid.

A preferred form of this invention also includes a fulcrum running perpendicular to the shaft and preferably on a side of the shaft opposite the direction in which the tooth extends from the shaft. This fulcrum is located so that it can rest upon a top surface of the lid or other cover when the tooth is inside the notch and engaging the lid or cover. Thus, when the tool is lifted, the tooth engages with the lid and lifts the lid. The fulcrum prevents the lid from rotating, so that the entire lid can be picked up even though the notch is not located at a center of gravity of the lid. Furthermore, a lever is preferably provided which can engage a rim of the hole covered by the lid so that the entire arm can act as a lever arm about a foot of the lever at a lower end of the lever, and the entire lid can be pried up somewhat, especially when the lid might be jammed into a closed position. The tool is thus effective both in moving manhole covers and particularly in moving smaller lids very quickly and easily.

### OBJECTS OF THE INVENTION

Accordingly, a primary object of the present invention is to provide a tool for handling both manhole covers and smaller utility lids or covers, such as G-5 lids.

Another object of the present invention is to provide authorized personnel with quick and easy access to the contents of manholes and utility service boxes.

Other further objects of the present invention will become apparent from a careful reading of the included drawing figures, the claims and detailed description of the invention.

### BRIEF DESCRIPTION OF THE DRAWINGS

FIG. 1 is a perspective view of a lower end of the tool of this invention.

FIG. 2 is a rear elevation view of that which is shown in FIG. 1.

FIG. 3 is a side elevation view of that which is shown in FIG. 1.

FIG. 4 is a side elevation view of that which is shown in FIG. 1 and shown in use lifting a G-5 lid out of a utility service hole.

FIG. 5 is a perspective view of the tool in use lifting a lid from a utility service hole.

FIG. 6 is a perspective view of the tool of this invention in use removing a rectangular utility service hole lid.

FIG. 7 is a perspective view of the tool of this invention in use lifting an edge of a manhole cover to access the manhole.

### DESCRIPTION OF THE PREFERRED EMBODIMENT

Referring to the drawings, wherein like reference numerals represent like parts throughout the various drawing figures, reference numeral 10 is directed to a tool (FIG. 5) for use in lifting both manhole covers C and lids L of smaller utility service boxes.

Specifically, and with particular reference to FIGS. 5-7, details of upper portions of the tool 10 are described. The tool 10 includes an elongate arm 20 preferably formed of a strong rigid material such as steel. A handle 30 is preferably provided at an upper end of the arm 20. This handle 30 provides a convenient location for the user to grasp the upper portion of the arm 20 and position the tool 10 where desired for manipulating a lid L or cover C according to this invention. The arm 20 in at least one embodiment is made out of ⅝ inch width/diameter cold rolled steel and heat treated. The length of the arm 20 can vary, but is typically approximately 36 inches in length. Alternatively, the arm 20 and other portions of the tool 10 could be forged as a single piece.

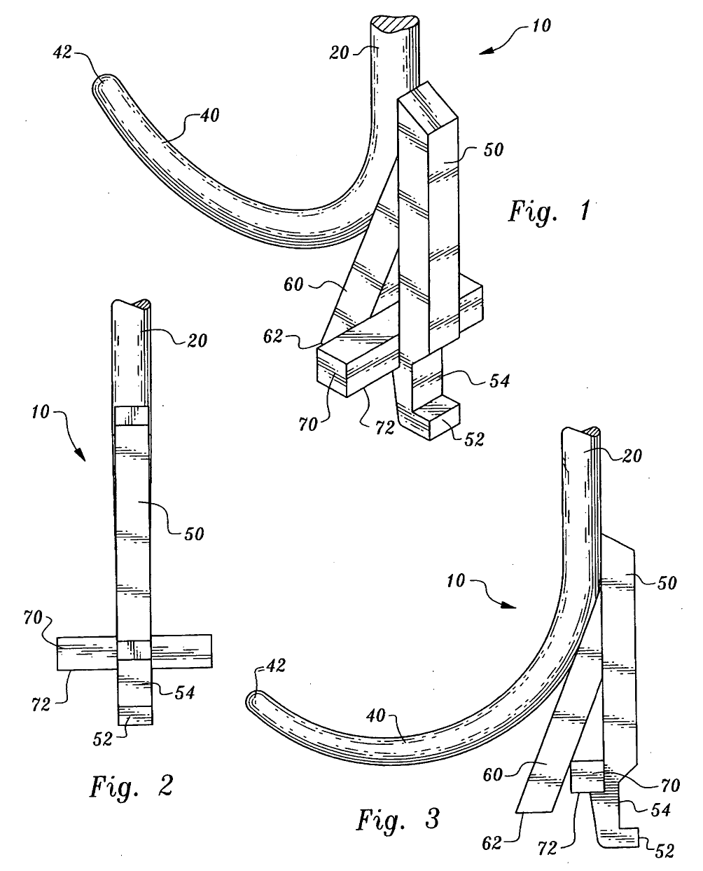

With particular reference to FIGS. 1-4, details of the lower portion of the tool 10 are described. This lower portion of the tool 10 generally includes a manhole hook portion 40 and a smaller lid L lifting portion formed primarily of the shaft 50. The hook 40 is preferably formed along with the arm 20 by curving a lower end of the arm 20 in an arcuate fashion, as particularly shown in FIGS. 1, 3 and 4. This curve in the hook 40 extends to a tip 42. Preferably, the tip 42 is sized small enough to pass into a notch at an edge of a manhole cover C (FIG. 7) so that a user can lift up on the tool 10 and cause the edge of the manhole cover C to be lifted up away from the manhole. The manhole cover C can then be pivoted to the side to provide access to the manhole. Similarly, the tip 42 of the hook 40 can engage the notch in the cover C when it is away from the manhole cover C to lift one side of the manhole cover C and rock the manhole cover C back into position over the manhole when access to the manhole is no longer required.

The shaft 50 is preferably welded onto a lower portion of the arm 20 near where the arm 20 begins to curve to form the hook 40. In particular, the shaft 50 extends vertically down from a lower portion of the arm 20 and preferably has a square cross-section of approximately 7/16 inch. The length of the shaft 50 is preferably 4¼ inches. Preferably, an upper end of the shaft 50 is beveled slightly so that a rear side of the shaft 50 is a ¼ inch below a front side of the shaft 50.

A lower end of the shaft 50 includes a tooth 52. The tooth 52 is formed by carving a recess 54 in a rear side of the shaft 50 on a portion of the shaft above the tooth 52. The tooth 52 preferably is ¼ inch tall and the recess is preferably ¼ inch deep, such that the tooth sticks approximately ¼ inch away from where the tooth 52 attaches to the shaft 50. The recess 54 preferably has a height of ⅝ inch before it begins to taper back to the vertical rear surface of the shaft 50. This tapering portion is preferably ¼ inch in height.

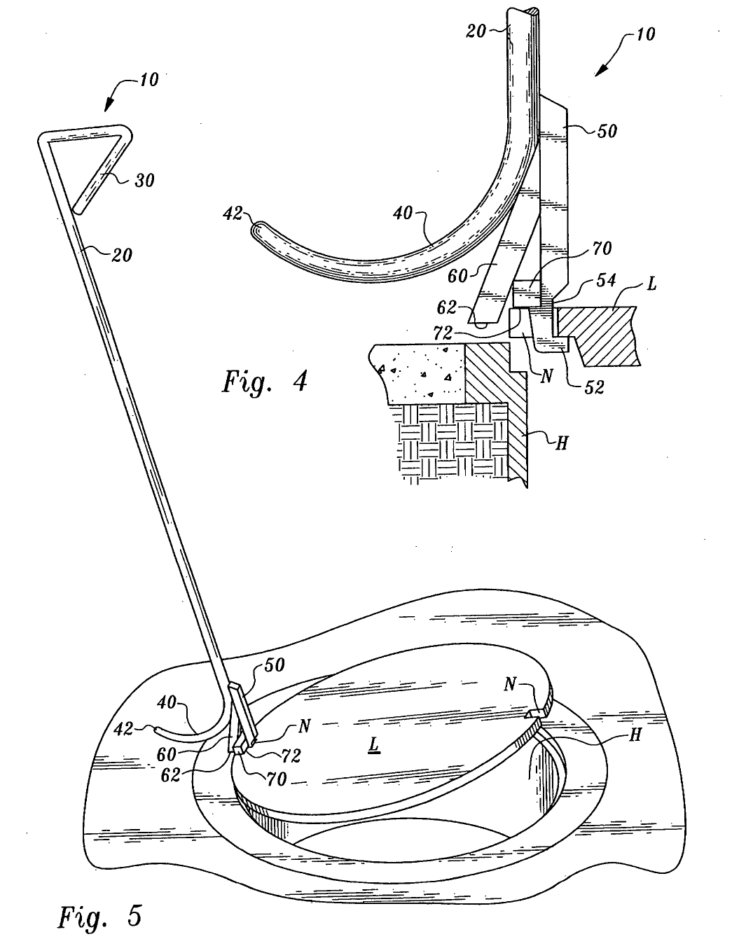

The recess and tooth are sized along with the shaft 50 so that the tooth 52 can slide into a notch N of a lid L (FIG. 5) with the tooth engaging a lip formed in the lid L (FIG. 4). In this way, the shaft 50 and tooth 52 can be used to engage the lid L and lift the lid L out of position.

Most preferably, the lifting of the lid L is enhanced by adding a lever 60 extending diagonally from a forward side of the shaft 50 and between the shaft 50 and the hook 40. This lever 60 is preferably formed of 7/16 inch square stock from a similar material as that forming the shaft 50, such as hardened steel. The shaft 50 and lever 60 are preferably welded to the arm 20 and hook 40 so that the entire assembly is rigidly held together. A lower end of the lever 60 preferably includes a foot 62 thereon. This foot can engage a rim of the hole H (FIG. 4) in which the lid L is initially located. Thus, a user can rotate the arm with the foot 62 of the lever 60 acting as a pivot point so that significant force can be applied to the lid L to lift the lid L away from the hole H. Such an arrangement is particularly useful when the lid L is stuck within the hole H.

Most preferably, a fulcrum 70 is also provided welded rigidly to the shaft 50 and optionally also the lever 60. The fulcrum 70 is preferably formed of 7/16 inch square hardened steel stock similar to that forming the shaft 50 and the lever 60. The fulcrum 70 is preferably oriented horizontally perpendicular to the shaft 50 and perpendicular to a plane in which the hook 40 curves. An additional weld area is preferably provided below the fulcrum 70 and adjacent a forward side of the shaft 50. The fulcrum 70 is located between the lever 60 and the shaft 50 so that, along with this additional weld area, the fulcrum 70 is held securely in place relative to other structures including the shaft 50 and the fulcrum 60.

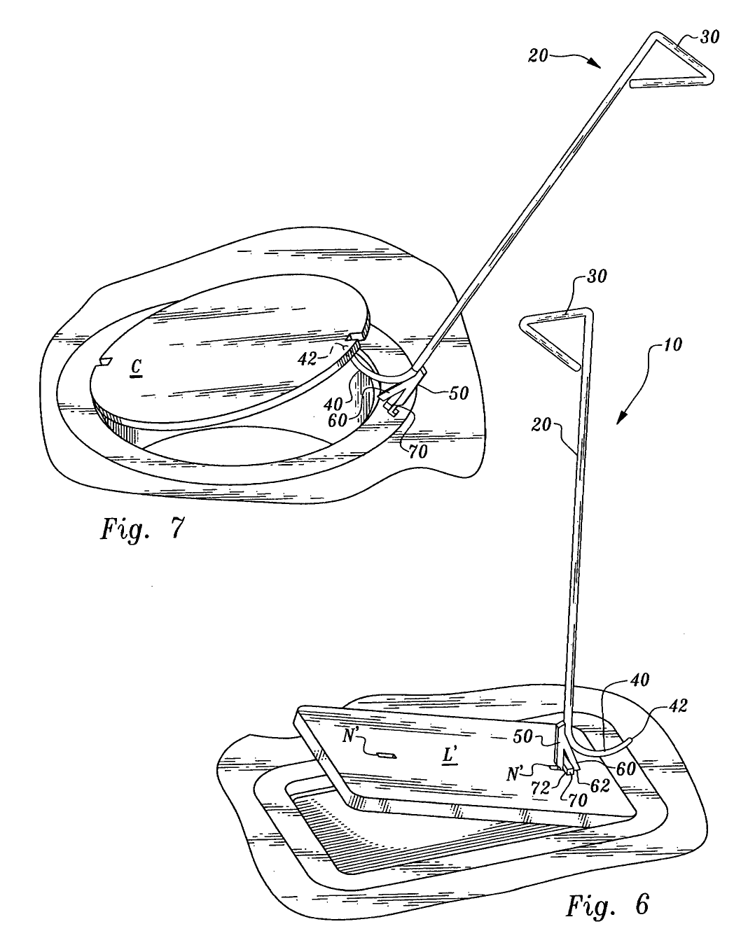

In use, and with reference to FIGS. 5 and 6, when the tooth 52 is inside the notch N and the tooth 52 is engaging an underside of the lid L, the fulcrum 70 is appropriately located so that it is resting against the lid L with the underside 72 of the fulcrum 70 in contact with an upper surface of the lid L. Thus, the lid L is somewhat trapped between the tooth 52 and the underside 72 of the fulcrum 70. When the tool 10 is lifted vertically (FIGS. 4 and 5) the lid L does not pivot, but rather remains substantially horizontal (FIG. 4). Thus, a user can lift the lid L out of position away from the hole H and set it on the ground adjacent the hole H. This procedure can be reversed to replace the lid L back over the hole H. Heretofore utilizing the prior art, a pair of tools were needed to work opposite notches N on the lid L (FIG. 5). With this invention, a single tool 10 accessing only one of the notches N in the lid L can lift the entire lid L and place it where desired. When a quick inspection is required, this feature is particularly convenient as the tool 10 can remain attached to the lid L during the inspection.

Where standard electrical utility boxes having a rectangular lid are to be moved, the notch N′ in the utility box lid L′ (FIG. 6) are typically located inboard from edges of the lid L′. These notches N′ typically include a steel wire at a midpoint therein which can be engaged by the tooth 52 of the shaft 50. Accordingly, such rectangular utility lids L′ can be accessed with the tooth 52 at the lower end of the shaft 50 and the fulcrum 70 can be utilized so that the entire lid L′ can be either pivoted out of position or lifted entirely out of position with the tool 10 according to this invention.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified.

1-3. (canceled)

4. A tool for lifting a utility service lid having a notch in a perimeter thereof, the tool comprising in combination:
an elongate arm;
a shaft rigidly coupled to a lower end of said arm and extending substantially parallel with a long axis of said arm;
a tooth on said shaft extending laterally, said tooth adapted to engage a lower surface of the utility service lid when said shaft is located within the notch of the lid; and
a fulcrum rigidly coupled to said shaft having an underside oriented substantially perpendicular to said shaft, said underside adapted to abut an upper surface of the lid.

5. The tool of claim 4 wherein said shaft has a square cross-section with a recess above said tooth, said tooth extending horizontally from said shaft when said shaft is oriented vertically, with said tooth located below and adjacent said recess in said shaft.

6. The tool of claim 4 wherein said tooth is spaced vertically from said underside of said fulcrum by a distance substantially equal to a thickness of the lid.

7. The tool of claim 6 wherein said fulcrum is wider than said shaft with a long axis of said fulcrum oriented perpendicular to said shaft.

8. The tool of claim 6 wherein a lever is rigidly coupled to said shaft and extends diagonally from said shaft on a side of said shaft opposite said tooth, said fulcrum located between said lever and said shaft.

9. The tool of claim 8 wherein said lever has a foot at a lower end thereof, said foot adapted to engage a surface adjacent said lid to assist in prying the lid away from surfaces adjacent the lid.

10. The tool of claim 4 wherein a lever is rigidly coupled to said shaft and extends diagonally from said shaft on a side of said shaft opposite said tooth, said fulcrum located between said lever and said shaft.

11. The tool of claim 4 wherein a hook is coupled to said arm and curving away from said long axis of said arm and away from said shaft in a plane coplanar with said shaft and said arm, said hook extending to a tip adapted to be placed within a notch in a manhole cover.

12. A utility surface lid handling tool, comprising in combination:
an elongate rigid arm;
a tooth at a lower portion of said arm extending laterally relative to a long axis of said arm, said tooth sized to pass through a notch in the lid and engage a lower surface of the lid; and
a fulcrum surface oriented within a plane substantially perpendicular to said long axis of said arm, said fulcrum surface spaced above said tooth by a distance similar to a thickness of the lid, such that said fulcrum surface is adapted to abut an upper surface of the lid when said tooth is engaging a lower surface of the lid.

13. The tool of claim 12 wherein said fulcrum surface is rigidly coupled to said tooth.

14. The tool of claim 12 wherein said tooth is located upon a shaft extending down from a lower end of said arm, said fulcrum located on a side of said shaft opposite said tooth, said shaft having a size sufficiently small to pass into the notch in the lid so that said tooth can engage the lower surface of the lid.

15. The tool of claim 14 wherein a hook is located on a lower end of said arm, said hook curving away from a long axis of said arm and away from said shaft.

16. The tool of claim 15 wherein said hook and said shaft are oriented in a common plane along with said arm.

17. The tool of claim 16 wherein a lever is affixed to said shaft and extending diagonally away from said shaft and between said hook and said shaft.

18. The tool of claim 17 wherein said lever has a foot at a lower end thereof most distant from said shaft, said foot located below said fulcrum surface.

19. The tool of claim 12 wherein said fulcrum surface is located upon a fulcrum piece affixed to said arm, said fulcrum piece having a long axis extending perpendicular to a long axis of said arm.

20. The tool of claim 19 wherein said fulcrum piece has a length greater than a width of said tooth, such that said tooth can pass into the notch in the lid while the fulcrum piece is sufficiently wide to engage the upper surface of the lid without passing into the notch.

21. The tool of claim 20 wherein said fulcrum piece is rigidly coupled to said arm.
